(19) United States
(12) Patent Application Publication
(10) Pub. No.: US 2014/0037365 A1
(43) Pub. Date: Feb. 6, 2014

(54) FINGER GUARD

(71) Applicant: Sean Edwin Moran, Montmorency (AU)

(72) Inventor: Sean Edwin Moran, Montmorency (AU)

(73) Assignee: FUNTASTIC LIMITED, Chadstone, Victoria (AU)

(21) Appl. No.: 14/009,997

(22) PCT Filed: Apr. 5, 2012
(86) PCT No.: PCT/AU2012/000350

§ 371 Date: Oct. 4, 2013

(30) Foreign Application Priority Data
Apr. 7, 2011 (AU) 2011901297

(51) Int. Cl. F16C 11/04

(52) U.S. Cl. CPC F16C 11/04
USPC 403/23

(57) ABSTRACT

A guard (50) is provided for a joint between first (12) and second (14) pivotally interconnected members. The members (12, 14) are pivotable from a first position to a second position about a pivot axis (82) on one side of the members (12, 14), thereby creating a gap between the two members. The gap has a widest part opposite the pivot axis and sides of the gap extend between the widest part and the pivot axis. The guard (50) includes a plurality of shroud portions (52, 54, 56, 58). Each shroud portion (52, 54, 56, 58) is formed as a partial enclosure including side wall portions (66, 72) on opposite sides of the gap. The partial enclosure extends continuously from one side of the gap to the other side of the gap including across the widest part of the gap. The plurality of shroud portions (52, 54, 56, 58) are nested together when the members (12, 14) are in the first position and are movable relatively apart to form a shroud over the widest part and the sides of the gap when the members (12, 14) are in the second position.

### FIELD OF THE INVENTION

The present invention relates to a guard for a hinged joint. In particular, although not exclusively, the invention relates to a finger guard for a hinged joint on a push stroller (child's push chair), pram (perambulator) or other compactable apparatus. While the invention is specifically described in connection with a push stroller, it is to be understood that the invention is not limited in its application thereto and may be applied to any kind of compactable apparatus where there is a risk of entrapment of the user's or occupant's fingers or other body parts, generally when the compactable apparatus is being assembled or disassembled. The invention also relates to a hinged joint.

### BACKGROUND OF THE INVENTION

In any compactable apparatus such as push strollers, there are a number of joints where two members are hinged relative to one another. For example, in a typical push stroller as described in US patent publication 2006/0267303 as shown in FIG. 6, there are two upright struts 30′ which extend upwardly from the body of the stroller and define a push handle for the parent or guardian to push the stroller. Each of these uprights 30′ is made up of struts 20, 28 terminating at first and second members 12′, 14′ which are pivotally interconnected at a hinged joint. In the assembled configuration of the stroller, the two members 12′, 14′ extend in line with one another. The pivot axis 82 is generally offset from the two members 12′, 14′ which enables the two members to disconnect and pivot relative to one another, when the stroller is being moved to its compacted configuration. Thus it will be appreciated that a gap will open up between the two members 12, 14′ as they are moved to the compacted configuration. As can be seen from FIG. 6, the gap has a widest part opposite the pivot axis 82 and sides of the gap extend between the widest part and the pivot axis 82. Thus, when the two members 12′, 14′ are moved from the compacted configuration back to the erected configuration, the gap between the two members 12′, 14′ will close, thus creating a pinch point in which fingers or other body parts may be caught.

Accordingly, it is an object of the present invention to provide a guard for a joint and/or a compactable apparatus and/or a pram or stroller which substantially overcomes or at least ameliorates the aforementioned disadvantages. It is another object of the present invention to provide the public with a useful choice over known devices.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In accordance with a first aspect of the present invention there is provided, a guard for a joint between first and second pivotally interconnected members which are pivotable from a first position to a second position about a pivot axis on one side of the members, thereby creating a gap between the two members, said gap having a widest part opposite the pivot axis and sides of the gap extending substantially between the widest part and the pivot axis, the guard including a plurality of shroud portions, each shroud portion formed as a partial enclosure including side wall portions on opposite sides of the gap, said partial enclosure extending continuously from one side of the gap to the other side of the gap, including across the widest part of the gap, wherein the plurality of shroud portions are nested together when the members are in the first position and are movable relatively apart to form a shroud over the widest part and the sides of the gap when the members are in the second position.

In the guard, there may be only two shroud portions (the first and second shroud portions). This limited number of shroud portions may be sufficient in certain situations where the first and second members only pivot to a limited degree, e.g. 45° or 90°. However, with greater degrees of relative movement between the two members, additional shroud portions will be required. Preferably, there are at least 3 shroud portions. Preferably, there are two additional shroud portions, making up four shroud portions in total. However, there may be five shroud portions or six shroud portions.

The shroud portions may include a first shroud portion which is adapted to be stationary relative to the first member and a second shroud portion which is adapted to be stationary relative to the second member. The first and second shroud, portions may be fixable/fixed relative to the first and second members respectively. This will ensure that the first and second shroud portions remain stationary relative to the first and second members respectively, as the first and second members pivot. In so doing, the first and second shroud portions move apart from each other.

Preferably, any additional shroud portions are disposed between the first and second shroud portions, in a nested way. Any additional shroud portions may be free floating. All of the shroud portions may be biased apart from each other so that they tend to form a complete shroud when the first and second members move towards the second position. In a most preferred form of the invention, each of the plurality of shroud portions is interconnected to one or both of its neighbouring shroud portions. For example, as the second member and the associated second shroud portion move relative to the first member and the first shroud portion, the second shroud portion moves apart from its neighbouring shroud portion, until it reaches its furthest extent from its neighbour, whereupon the neighbour is drawn apart from its immediate neighbour, and so on. In effect, the shroud portions are pivotally telescopic. The shroud portions may be interconnected in any suitable manner. In one form of the invention, each of two neighbouring shroud portions may have shoulders which inter-engage when the neighbouring shroud portions have moved apart a predetermined amount. This causes the two neighbouring shroud portions to then operate as a unit and pull on the succeeding shroud portion.

The shroud portions may be pivotally interconnected about a common pivot. For example, the shroud portions may pivot about the same pivot as the first and second members. Preferably, the plurality of shroud portions are shaped to facilitate movement about the pivot between the nested and the spaced apart configuration.

Each of the shroud portions is formed as a partial enclosure including side wall portions on opposite sides of the gap, said partial enclosure extending continuously from one side of the gap to the other side of the gap, including across the widest part of the gap. Each shroud portion may thus have at least 3 discrete wall portions including the side wall portions and a third wall portion extending across the widest part of the gap i.e. having a rectangular cross-section in a plane including the pivot axis. However, the form of each of the shroud portions is not limited to this shape. The cross-sectional shape in a plane including the pivot axis may be curved, arcuate or circular. In this case, there is only a single continuous wall extending from one side of the gap to the other side of the gap which wall includes the two side wall portions. Such a shape may be particularly appropriate when the members are circular in transverse cross-section.

Preferably, the partial enclosures are hollow enclosures which are also open on the side of the pivot axis. Preferably, in this form, the third wall portion opposite the pivot axis is arcuate. Preferably, the axis of curvature for the arcuate wall is the pivot axis.

As the plurality of shroud portions are nestable together, preferably the shroud portions are of a slightly different size, enabling each shroud portion to fit within one neighbour and to accommodate its other neighbour, with a small clearance provided therebetween.

The first shroud portion may be fixed to the first member, preferably without gaps. Likewise, the second shroud portion may be fixed to the second member.

In accordance with a second aspect of the present invention, there is provided a compactable apparatus including: a joint formed between first and second pivotally interconnected members which are pivotable from a first position to a second position; and a guard as set out above in the first aspect of the invention.

Preferably, the two pivotally interconnected members comprise elongate bars or housings to accommodate elongate bars. These elongate bars may define an upwardly extending strut or frame member of a compactable stroller. The bars or housings may be of any cross-section such as square, rectangular or circular and the guard may be of a commensurate shape in a cross-section which includes the pivot axis. In the first position, the two members are preferably in line with each other. In the second position, the two members are preferably moved through 180°, to lie alongside each other in a compacted configuration. The invention may also have application to other compactable apparatus such as prams, portable cots and foldable highchairs.

Any of the features described above in connection with the first aspect of the invention may be applied to the second aspect of the invention.

In accordance with a third aspect of the present invention, there is provided a push stroller or pram including: a joint formed between first and second pivotally interconnected members which are pivotable from a first position to a second position; and a guard as set out above in accordance with the first aspect of the invention.

Any of the features described above in connection with the first and second aspects of the invention may be applied to the third aspect of the invention.

In accordance with a fourth aspect of the present invention, there is provided a compactable apparatus such as a push stroller or pram, said compactable apparatus including:

a support frame including first and second frame members and a joint formed between said first and second frame members to pivotally interconnect said members, the members being pivotable from a first position to a second position in which a gap is created between the two members; and

a guard associated with the hinged joint, wherein the guard is extendable from a retracted position when the members are in the first position and to an extended position to form a shroud to cover the gap when the members are in the second position.

Any of the features described above in connection with the first, second and third aspects of the invention may be applied to the fourth aspect of the invention. For example, the guard may be resiliently extendable, for example, by the resilience of the material employed or by the nature of the construction e.g. concertina construction.

As used herein, except where the context requires otherwise, the term “comprise” and variations of the term, such as “comprising”, “comprises” and “comprised”, are not intended to exclude further additives, components, integers or steps.

It will be understood that the invention disclosed and defined in this specification extends to all alternative combinations of two or more of the individual features mentioned or evident from the text or drawings. All of these different combinations constitute various alternative aspects of the invention.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

In order that the invention may be more fully understood, one embodiment will now be described by way of example, with reference to the figures in which:

FIG. 1 is an exploded perspective view of a hinged joint with a finger guard, in accordance with a preferred embodiment of the present invention;

FIG. 2 is an assembled view of the hinged joint with finger guard shown in FIG. 1;

FIG. 3 is a perspective view illustrating the application of the finger guard to the upwardly extending struts of a push stroller;

FIG. 4 is a perspective view of the push stroller incorporating the finger guard shown in FIG. 1;

FIG. 5 is a perspective view of the push stroller in the compacted configuration; and

FIG. 6 is a perspective view of a prior art version of a push stroller shown in a semi-compacted configuration.

### DESCRIPTION OF THE FIGURES

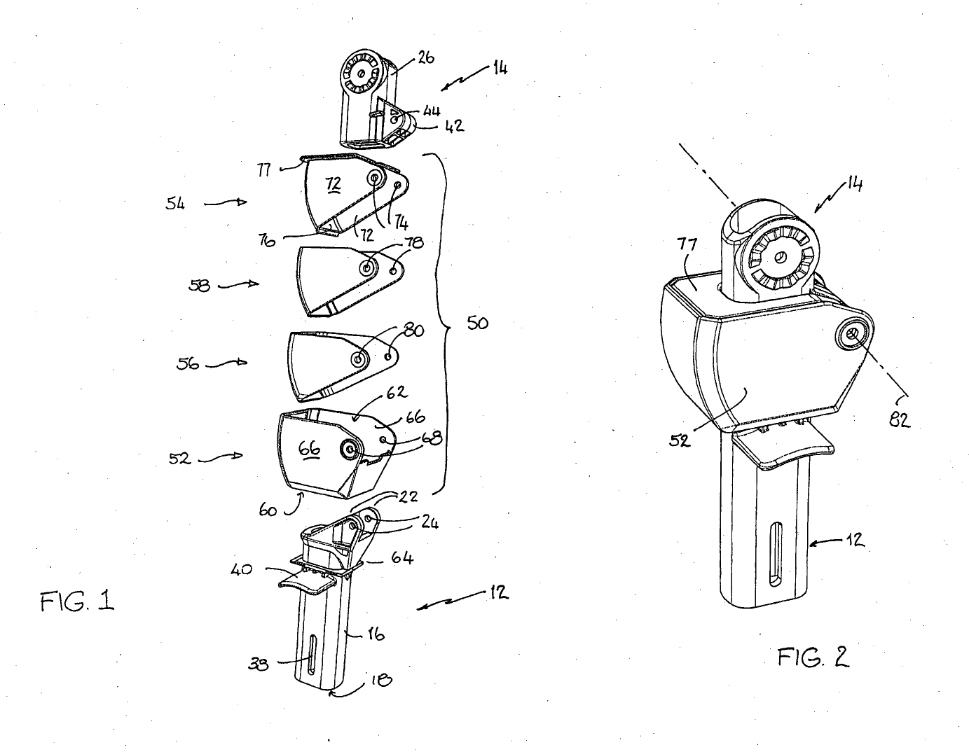

FIG. 1 is an exploded perspective view of the hinged joint 10 which is shown in assembled configuration in FIG. 2. The hinged joint 10 includes first and second pivotally interconnected members 12, 14 respectively.

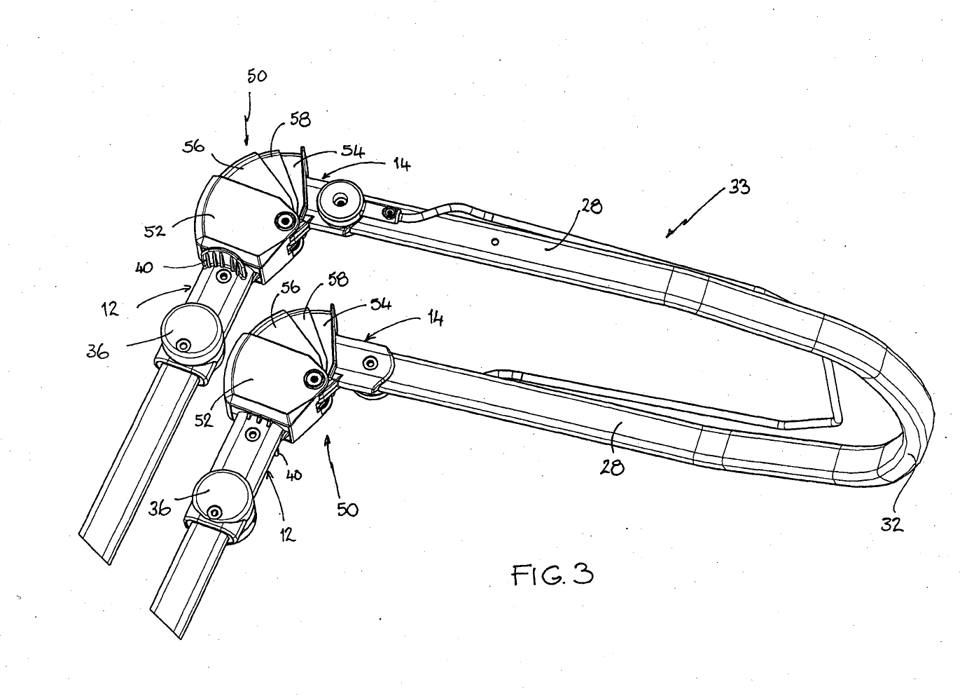

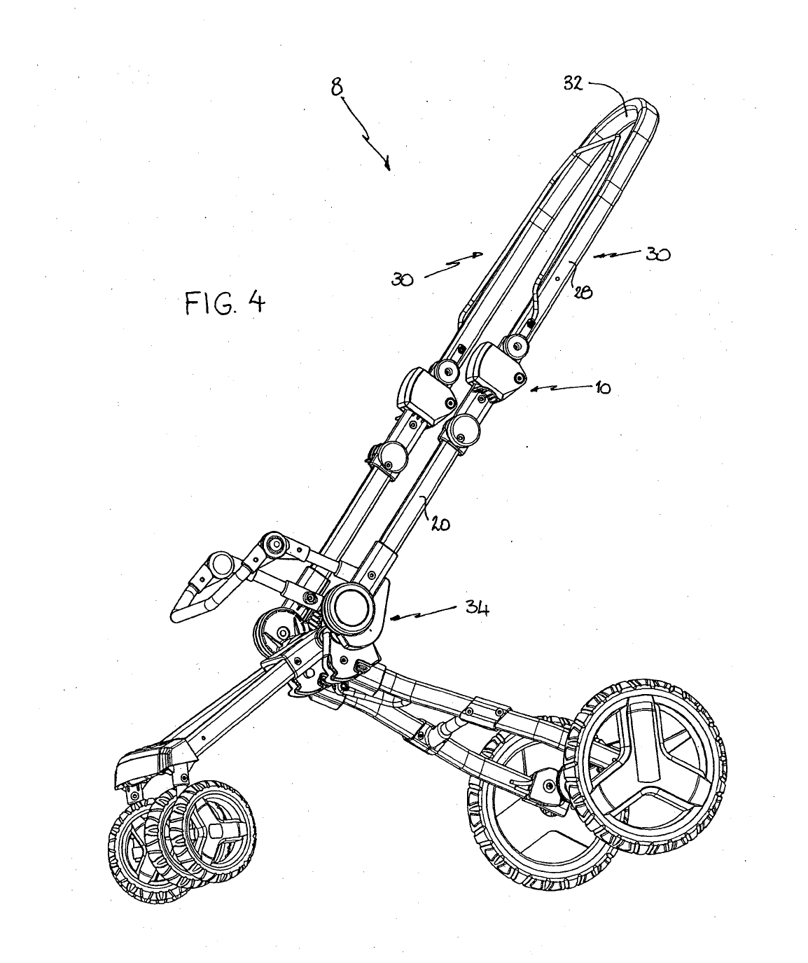

Member 12 comprises a hollow tubular portion 16 having a first open end 18 to receive an elongate bar 20 (see FIG. 4). The second opposite end of the member 12 has two ears 22. The ears 22 each have a through hole 24, the two of which are aligned in order to receive a pivot pin (not shown). The first member 12 may be a one piece plastic moulded housing.

Likewise, the second member 14 may also be a one piece moulded plastic housing comprising a hollow tubular portion 26 which receives the end of an elongate bar 28 as shown in FIG. 4.

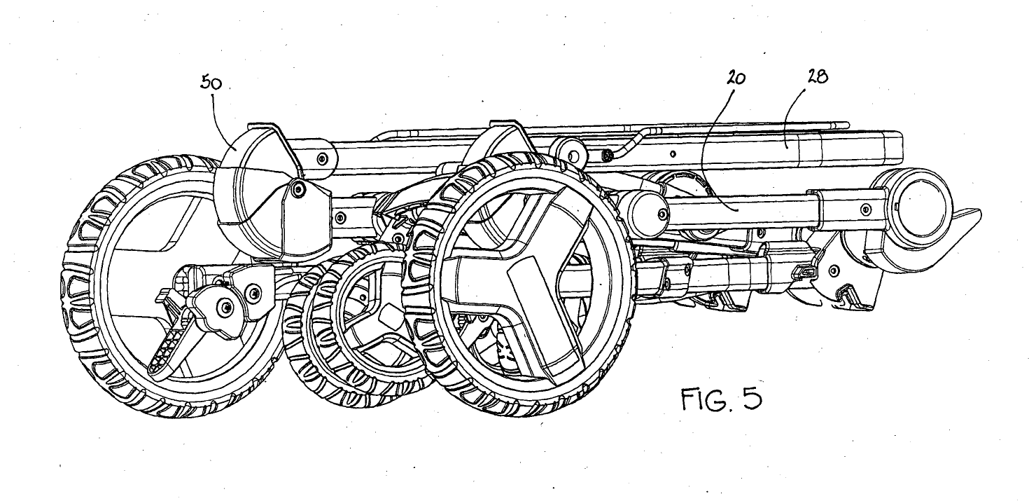

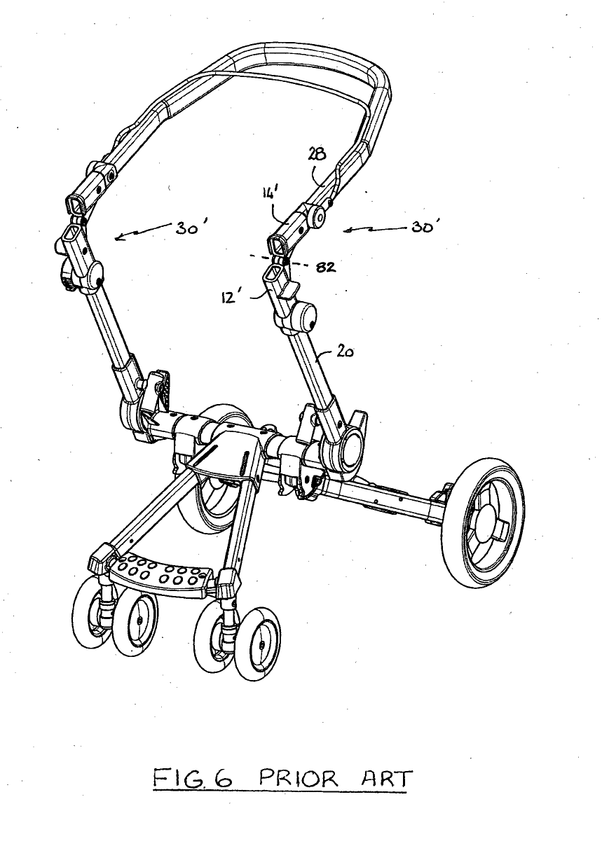

As will be appreciated from FIG. 4, the elongate bars 20 and 28 define an upwardly extending strut 30. There are two such struts 30 joined by a central arcuate portion 32 to make up a U-shaped frame member extending from a central body 34 of the stroller 8. The two upper elongate bars 28 together with the arcuate portion 32 define the handle portion 33 of the stroller 8. In use, the stroller may be compacted to the configuration illustrated in FIG. 5. The folding operation will be understood more clearly from a study of Australian patent specification number 2006202465 and US patent specification 20060267303, the details of which are incorporated herein by reference. The reader is directed to those other specifications for a full explanation of how the stroller 8 compacts.

Suffice to say, in the case of each strut 30, the user folds the U-shaped frame, by operating the actuation mechanism disposed at each hinged joint. Referring to FIG. 3, the actuating mechanism on each side includes a knob 36. The knob 36 is movable in the slot 38 on the first member 12 as shown in FIG. 1. The flange 40 is provided as a palm rest to enable the user to pull the knob 36 upwardly with his fingers, while his palm is supported by palm rest 40. Actuation in this manner releases a locking mechanism (not shown) which retains the first and second members 12, 14 in aligned configuration. Such actuation is provided on both of the struts 30, so the actuation process is a two handed operation. On actuation, the handle portion 33 of the U-shaped frame member collapses under its own weight in the manner illustrated in FIG. 3. The handle portion 33 is then folded until the elongate bars 28 rest alongside the elongate bars 20 as shown in the compacted configuration of FIG. 5.

Reverting to FIG. 1, to facilitate this folding operation, the second member 14 is pivotally connected to the first member 12. The first member 14 which is a unitary plastic moulded housing also has a spigot portion 42 having a through hole 44 extending therethrough. The spigot portion 42 is received between the ears 22 of the first member 12 with the through hole 44 aligned with the holes 24 and a pivot pin is inserted therethrough. This enables the second member to pivot relative to the first member 12. It will be appreciated that as the second member 14 pivots relative to the first member 12, the near end of the hollow tubular portion 26 will move away from the near end of the hollow tubular portion 16 of the first member 12. This creates a gap (not shown) which when the second member 14 pivots back again, will create a pinch point in which the user's or the occupant's fingers or another body part may be caught. Parts of the locking mechanism (not shown) which are disposed at this juncture may also create a hazard.

This potential hazard can be avoided by the provision of a guard 50. The guard 50 is made up of a first shroud portion 52 which is fixed to the first member 12, a second shroud portion 54 which is fixed to the second member 14, and third and fourth shroud portions 56, 58.

The first shroud portion 52 is a walled enclosure having a lower opening 60 and an upper opening 62. The lower opening 60 is shaped to receive the hollow tubular portion 16. For this purpose, the hollow tubular portion 16 is provided with a peripheral flange 64, which provides a seat for the lower end of the first shroud portion 52. The outer periphery of the peripheral flange 64 and the first shroud portion 52 are fitted together, leaving minimal gaps. The first shroud portion 52 is also provided with opposite side walls 66 which have aligned holes 68 which align with the holes 24 in the ears 22. The opposite wall 70 is curved with the axis of curvature lying along the pivot axis 82.

The second shroud portion 54 is a three-sided walled enclosure having two side walls 72 which are provided with aligned holes 74 which are coincident with the pivot axis 82. The wall 76 adjoining the side walls 72 is arcuate with its axis of curvature being coincident with the pivot axis 82. The walls 72, 76 are provided with an outwardly projecting peripheral flange 77. This peripheral flange 77 is seated on or within the upper end of the walls 66, 70 when the second shroud portion 54 is fully nested within the second shroud portion 52. The second shroud portion 54 also has an upper opening (not shown) which receives the second member 14. The second shroud portion 54 is fixed to the second member 14 and the holes 74 align with the through hole 44.

The third and fourth shroud portions 56, 58 are in substantially the same form as the second shroud portion 54, except with the omission of the peripheral flange 77. When the first and second member 12, 14 are assembled together with the guard 50, the holes 24, 44, 68, 74 and 78 and 80 are aligned to receive pivot pin which defines a single pivot axis 82 as shown in FIG. 2.

When the first and second members 12, 14 are in alignment as shown in FIG. 2, the first shroud portion 52 receives the second shroud portion 54, the third shroud portion 56 and the fourth shroud portion 58 so that the only part visible is the peripheral flange 77 of the second shroud portion 54. As the second member 14 is pivoted relative to the first member 12, given that the second shroud portion 54 is fixed to the second member 14, the second shroud portion 54 will rotate with the second member 14. Thus, the second shroud portion 54 begins to rotate out of the first shroud portion 52. The second shroud portion 54 is interconnected with the fourth shroud portion 58 so that when the second shroud portion 54 has moved apart from the fourth shroud portion 58 by a predetermined amount, the fourth shroud portion 58 will start to move with the second shroud portion 54. Likewise, the fourth shroud portion 58 and the third shroud portion 56 are interconnected so that when the fourth and third shroud portions 58, 56 have moved apart to a predetermined extent, the third shroud portion 56 will begin to be withdrawn from the first shroud portion 52. FIG. 3 illustrates the partial deployment of the guard 50 whereas FIG. 5 illustrates the full deployment of the guard 50. The guard 50 particularly protects the user or the occupant when the first and second members 12, 14 are returned to their aligned configuration. In so doing, the gap created therebetween will define a pinch point but the guard 50 presents a shroud around the gap and the pinch point, protecting the user and the occupant.

The foregoing describes only one embodiment of the present invention and modifications may be made thereto without departing from the scope of the invention.

1. A guard for a joint between first and second pivotally interconnected members which are pivotable from a first position to a second position about a pivot axis on one side of the members, thereby creating a gap between the two members, said gap having a widest part opposite the pivot axis and sides of the gap extending substantially between the widest part and the pivot axis, the guard including a plurality of shroud portions, each shroud portion formed as a partial enclosure including side wall portions on opposite sides of the gap, said partial enclosure extending continuously from one side of the gap to the other side of the gap, including across the widest part of the gap, wherein the plurality of shroud portions are nested together when the members are in the first position and are movable relatively apart to form a shroud over the widest part and the sides of the gap when the members are in the second position.

2. The guard as claimed in claim 1 wherein each shroud portion includes at least three discrete wall portions including the two side wall portions and a third wall portion extending therebetween to extend across the widest part of the gap.

3. The guard as claimed in claim 2 wherein the third wall portion is arcuate.

4. The guard as claimed in claim 3 wherein the axis of curvature for the third wall portion is the pivot axis.

5. The guard as claimed in claim 1 wherein one or more of the shroud portions are open towards the pivot.

6. The guard as claimed in claim 1 wherein the shroud portions are pivotally interconnected about a common pivot axis.

7. The guard as claimed in claim 6 wherein the shroud portions pivot about the same pivot axis as the first and second members.

8. The guard as claimed in claim 6 wherein said common pivot axis extends through the side wall portions of the shroud portions.

9. The guard as claimed in claim 1 wherein the plurality of shroud portions are shaped such that each successive shroud portion fits with the preceding shroud portion.

10. The guard as claimed in claim 1 wherein the shroud portions include a first shroud portion which is adapted to be stationary relative to the first member and a second shroud portion which is adapted to be stationary relative to the second member.

11. The guard as claimed in claim 1 wherein there are at least 3 shroud portions and each of the shroud portions is interconnected to one or both of its neighbouring shroud portions such that one of the shroud portion moves apart from its neighbouring shroud portion until it reaches its furthest extent from its succeeding neighbour, whereupon the succeeding neighbour is drawn apart from its succeeding neighbour.

12. The guard as claimed in claim 11 wherein each of two neighbouring shroud portions have shoulders which inter-engage.

13. A compactable apparatus including: a joint formed between first and second pivotally interconnected members which are pivotable from a first position to a second position; and a guard as claimed in claim 1.

14. A push stroller or pram including: a joint formed between first and second pivotally interconnected members which are pivotable from a first position to a second position; and a guard as claimed in claim 1.

15. The push stroller or pram as claimed in claim 14 wherein the two pivotally interconnected members comprise elongate bars or housings to accommodate elongate bars.

16. The push stroller or pram as claimed in claim 15 wherein, in the first position, the two members are in line with each other and in the second position, the two members are moved through 180°, to lie alongside each other in a compacted configuration.

17. A compactable apparatus such as a push stroller or pram, said compatable apparatus including:
a support frame including first and second frame members and a joint formed between said first and second frame members to pivotally interconnect said members, the members being pivotable from a first position to a second position in which a gap is created between the two members; and
a guard associated with the joint, wherein the guard is extendable from a retracted position when the members are in the first position and to an extended position to form a shroud to cover the gap when the members are in the second position.

18. The compactable apparatus as claimed in claim 17 wherein the guard is resiliently extendable.

19. The compactable apparatus as claimed in claim 18 wherein the guard is constructed from resilient material.

20. The compactable apparatus as claimed in claim 18 wherein the guard is constructed in a concertina fashion.
